(19) United States
(12) Patent Application Publication
(10) Pub. No.: US 2019/0215386 A1
(43) Pub. Date: Jul. 11, 2019

(54) LOW COST, HIGH BANDWIDTH REDUNDANT COMMUNICATION NETWORK

(71) Applicant: Honeywell International Inc., Morris Plains, NJ (US)

(72) Inventors: Byron Birkedahl, Glendale, AZ (US); Scott Gray, Peoria, AZ (US)

(73) Assignee: Honeywell International Inc., Morris Plains, NJ (US)

(21) Appl. No.: 15/866,402

(22) Filed: Jan. 9, 2018

(51) Int. Cl. H04L 29/14; H04L 12/707; H04L 1/22; H04L 12/24

(52) U.S. Cl. CPC H04L 69/40; H04L 41/0668; H04L 1/22; H04L 45/22

(57) ABSTRACT

A redundant communication network is provided. A first set of network interface controllers form at least a first ring communication loop. At least one of the network interface controllers provide a gateway to at least one first client unit. The first set of network interface controllers include a first master network interface controller and a first backup master interface controller. A second set of network interface controllers form at least a second communication loop. At least one of the network interface controllers provide a gateway to at least one second client unit. The second set of network interface controllers include a second master network interface controller and a second backup master interface controller. The first master network interface controller and the first backup master interface controller are in a cross-side linked commutation configuration with the second master network interface controller and the second backup master interface controller.

### BACKGROUND

Critical communication data networks, such as an avionic communication data network, require the system to be extremely reliable. An aircraft includes a number of digital avionic components such as Traffic Alert and Collision Avoidance System (TCAS), autopilot, Flight Management Systems (FMS) and integrated radio systems all communicating over a system network of data busses. To provide the required reliability, a redundant bus system has been used so that if one data bus fails, another is still available to provide communications. Network standards such as the Avionics System Communications Bus (ASCB) allow avionic components within the aircraft to work together safely and efficiently. ASCB is a synchronized networking protocol that allows each aircraft component to have an allotted share of a guaranteed bandwidth within the redundant data buses.

While the use of ASCB with its redundant data busses provide reliability necessary for avionic applications, redundant bus architectures typically have disadvantages. For example, the prior redundant bus systems provide significantly lower bandwidth than comparable non-avionic systems. Moreover, prior art buses are relatively expensive to implement because they have not been readily adopted for non-avionic applications.

### SUMMARY

The following summary is made by way of example and not by way of limitation. It is merely provided to aid the reader in understanding some of the aspects of the subject matter described. Embodiments provide a low cost, high band width redundant communication system.

In one embodiment, a redundant communication network that includes a first set of network interface controllers and a second set of network interface controllers. The first set of network interface controllers forms at least a first ring communication loop. At least one of the network interface controllers in the first set of network interface controllers providing a gateway to at least one first client unit. The first set of network interface controllers include a first master network interface controller and a first backup master interface controller. The second set of network interface controllers form at least a second communication loop. At least one of the network interface controllers in the second set of network interface controllers provide a gateway to at least one second client unit. The second set of network interface controllers include a second master network interface controller and a second backup master interface controller. The first master network interface controller and the first backup master interface controller of the first set of network interface controller are in a cross-side linked commutation configuration with the second master network interface controller and the second backup master interface controller of the second set of network interface controllers.

In another example embodiment, another redundant data communication network that includes a first set of network interface controllers and a second set of network interface controllers is provided. Each network interface controller in the first set of network interface controllers provides a gateway to at least one associated first client unit. Each network interface controller in the first set of network interface controllers is in communication with each of the other network interface controllers in the first set of network controllers in at least a first ring counter rotating redundant configuration to maintain data communications under fault conditions. Communication between the first set of network interface controllers are time synchronized. Each network interface controller in the second set of network interface controllers provides a gateway to at least one associated second client unit. Each network interface controller in the second set of network interface controllers is in communication with each of the other network interface controllers in the second set of network controllers in at least one second ring counter rotating redundant configuration to maintain data communications under fault conditions. Communication between the second set of network interface controllers being time synchronized.

The first set of network interface controllers include a first master network interface controller and a first backup master network interface controller and the second set of the network interface controllers including a second master network interface controller and a second backup master network interface controller. The first master network interface controller and the first backup master network interface controller in the first set of network interface controllers are in communication with the second master network interface controller and the second backup master network interface controller in the second set of network interface controllers in a cross-side link communication configuration. Communications between the first set of network interface controllers and the second set of network interfaces controllers via the first master network interface controller and a first backup master network interface controller and the second master network interface controller and a second backup master network interface controller further are time synchronized, wherein the time synchronization within the first set of network interface controllers, within the second set of network interface controllers and between the first set of network interface controllers and the second set of network interface controllers are maintained under multiple fault conditions.

In yet another embodiment, a network interface controller is provided. The network interface controller includes a data interface, a controller, a memory, a main power input, a first active coupler, a second active coupler and an auxiliary power input. The data interface is configured to couple communications between the network interface controller and at least one client. The controller is configured to control operations of the network interface controller. The memory is configured to store operation instructions executed by the controller. The main power input is configured to power circuitry of the network interface controller. The first active coupler is configured to provide a first communication connection to the network interface controller. The first active coupler is isolated from the circuitry powered via the main power input. The second active coupler is configured to provide a second communication connection to the network interface controller. The auxiliary power input is configured to couple an auxiliary power to the first active coupler such that the network interface controller may transfer data even if one of the network interface controller and the main power fails.

### BRIEF DESCRIPTION OF THE DRAWINGS

Embodiments can be more easily understood and further advantages and uses thereof will be more readily apparent, when considered in view of the detailed description and the following Figures in which:

FIG. 1 is a data communication network according to one exemplary embodiment;

FIG. 2 is a network interface controller according to one exemplary embodiment;

FIG. 3 is a diagram of data transmissions on each network side according to one exemplary embodiment; and

FIG. 4 a synchronization flow diagram according to one exemplary embodiment.

In accordance with common practice, the various described features are not drawn to scale but are drawn to emphasize specific features relevant to the subject matter described. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the embodiments, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

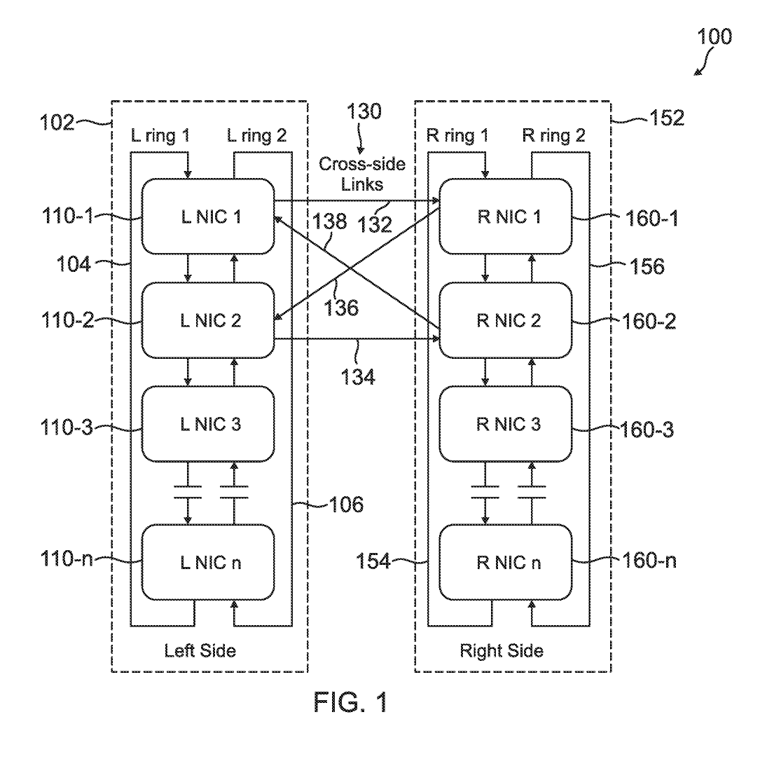

Embodiments provide a low cost, high band width redundant communication systems. Referring to FIG. 1, a block diagram of a data communication network 100 of an exemplary embodiment is illustrated. The data communication network can be applied to any type of communication system needing redundancy including, but not limited to, an Avionics system. The data communication network 100 applied to an avionic system provides a much higher bandwidth capability than the prior known systems, yet one that retains the data integrity and fault-tolerant redundancy needed for avionics systems.

The data communication network 100 includes a first side 102 (or left side) and a second side 152 (or right side) that each consist of a collection of Network Interface Controllers (NICs) 110-1 through 110-n and 160-1 through 160-n. Each NIC 110-1 through 110-n and 160-1 through 160-n provides a gateway of data to one or more attached client units which may include functionality for processing, I/O, memory storage and other types of functions typically included in a system, such as an avionics system. For example, in an avionic application, the clients may include, but are not limited to Traffic Alert and Collision Avoidance System (TCAS), autopilot, Flight Management Systems (FMS) and integrated radio systems.

The NICs 110-1 through 110-n and 160-1 through 160-n on each side of the data communication network 100 are connected together in a dual-redundant ring arrangement where data may be added by each NIC 110-1 through 110-n and 160-1 through 160-n and transferred around each of the rings in a counter-rotational direction. The counter-rotational data transfer is performed in order to ensure that if a single NIC has failed, data transfers between all the remaining operational NIC is maintained. A dual-redundant ring of the first side 102 includes a first ring connection route 104 and a second ring connection route 106. The dual-redundant ring of the second side 152 includes a first ring connection 154 route and a second ring connection route 166.

In addition, in embodiments, the first two NICs on each side 102 and 152 (NIC 110-1 and NIC 110-2 of first side and 160-1 and 160-n of the second side 152) are connected in a cross-side link communication configuration as shown in FIG. 1. In particular, NIC 110-1 is coupled via cross-side link 132 to NIC 160-1; NIC 106-1 is coupled via cross-side link 136 to the NIC 110-2; NIC 110-2 is coupled via cross-side link 134 to NIC 160-2; and NIC 160-2 is coupled via cross-side link 138 to NIC 110-1. The cross-side link communication configuration helps ensure that data from one side of the data communication network 100 is available on the other side of the data communication network 100. For example, if the communication cross-side link 132 from NIC 110-1 on the first side 102 to the second side 152 fails, communication cross-side link 134 between NIC 110-2 and NIC 160-2 still provides a communication link between the first side 102 of the network 100 to the second side 152 of the network 100. Similarly, if communication cross-side link 138 fails from NIC 160-2 of the second side to NIC 110-1, communication cross-side link 136 between NIC 160-1 to NIC 110-2 still provides a communication link between the second side 152 of the network 100 and the first side 102 of the network 100. Moreover, the dual-ring network topology of embodiments prevents a fault from propagating from one side to the other in a manner that could result in loss of the entire network. For example, the dual-ring network topology the NICs of each side independently control the propagation (and timing) of data on the rings. Data from the cross-side links is only consumed and placed on the rings. Therefore faults on one side (such as timing and propagation faults) that could take down that side cannot result in taking down the other side.

In addition, unlike known networks where the NICs are connected together in a passive-hub linear bus arrangement using older Ethernet technology, embodiments of the network 100 utilizes active couplers, described in detail below, that provide high speed point-to-point Ethernet connections between the NICs at 100 Mb/sec, 1000 Mb/sec, or higher speed.

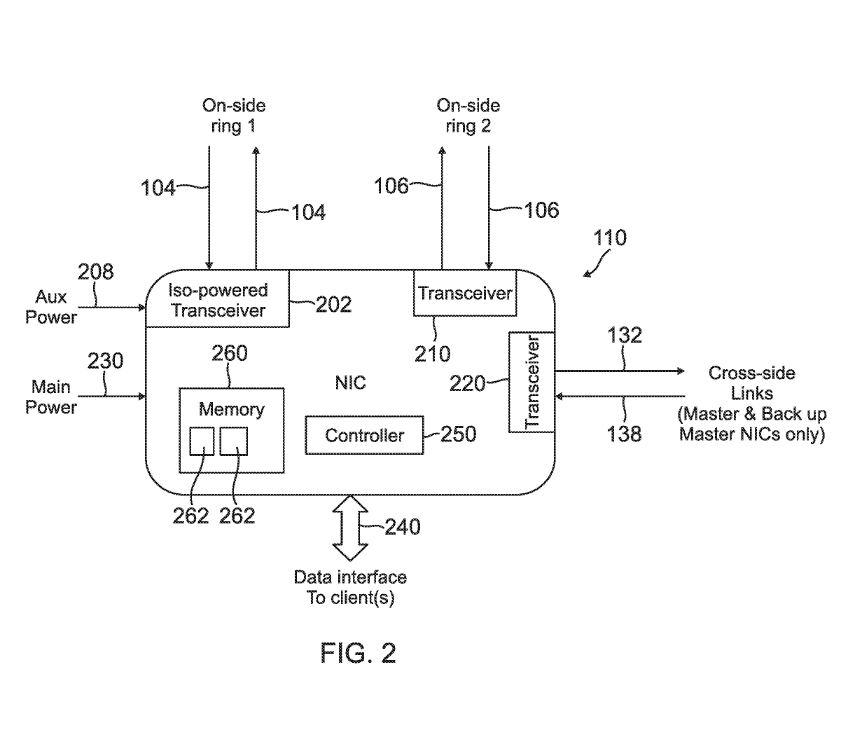

Referring to FIG. 2 an illustration of a NIC (generally designated as 110) of an embodiment that is used in the improved redundant communications network 100 is illustrated. NIC 110 has connections to its on-side rings (such as ring 104 and ring 106 of the first network side 102 of FIG. 1) via active couplers, such as first (or primary) active coupler 202 and second (or backup) active coupler 210, with active coupler circuits that contain standard Ethernet PHY circuits. The active couplers 202 and 110 further included transceivers to each establish a communication port with the NIC 110. The NIC 100 receives redundant Ethernet data on each ring 104 and 106, and via an algorithm decides which data to transfer to its clients via client interface 240. The client interface 240 is configured to be in communication with at least one client unit (not shown). In case of failure(s) on the ring, the algorithm will pick the ring data (from the first ring 104 or the second ring 106) that is received in the correct time slot from the correct NIC 110 that passes data integrity checks. For data transmitted by its clients, the NIC 110 adds the data to its outgoing Ethernet packets on both rings 104 and 106.

The first two NICs on each side of the network 100, such as 110-1 and 110-2 on the first side 102 of the network 100 and 160-1 and 160-2 on the second side 152 of the network 100 of FIG. 1 (which may be respectively designated as the master and back-up master NICs) also have connections to the master and backup master NICs on the other side of the network 100 via an Ethernet transceiver circuits in an embodiment. The master NIC, for example NIC 110-1 of the first side 102 of the network, receives data from the cross-side backup master NIC 160-2 on the second side 152 of the network and adds the data to one of the on-side rings (e.g. the first ring 104). The back-up master NIC, such as NIC 110-2 on the first side 102 of the network 100, receives data from the cross-side master NIC 160-1, and adds the data to the other on-side ring 106. This mechanism ensures that cross-side data is received by each network side 102 and 106 in the case of a failure of any master or back-up master NIC.

Referring back to FIG. 2, each NIC 110 has a main electrical power input 230 and an auxiliary power input 208. The main input electrical input 230 is used to power most of the NIC circuitry. The auxiliary input 208 only powers the active coupler circuity of the active coupler 202 connected to one of the rings (ring 104 in the diagram). The active coupler circuitry of active coupler 202 is isolated in a manner from the rest of the NIC circuitry such that a failure of the NIC 110 does not cause loss of this iso-powered active coupler 202. This design allows the ring 104 to continue to transfer data even if the NIC 110 has failed or the main power 230 has failed. Moreover, this design allows the ring 104 to continue to operate even if there are two or more NIC 110 failures on the ring 104.

The NIC110 may further have a third coupler 220 that includes a transceiver when the NIC 110 is used as one of the master and backup master 110-1, 110-2, 160-1 and 160-2. This provides the communication cross-side links, such as cross-side links 132 and 138. The NIC 110 further includes a controller 250 that controls operation of the NIC 110 and a memory 260 which stores instructions the controller 250 implements. In one embodiment, the memory stores data tables 262 that contain information that governs a frame rate and transmission timings of all the NICs on the network 100.

In general, the controller 250 may include any one or more of a processor, microprocessor, a digital signal processor (DSP), an application specific integrated circuit (ASIC), a field program gate array (FPGA), or equivalent discrete or integrated logic circuitry.

In some example embodiments, controller 250 may include multiple components, such as any combination of one or more microprocessors, one or more controllers, one or more DSPs, one or more ASICs, one or more FPGAs, as well as other discrete or integrated logic circuitry. The functions attributed to the controller 250 herein may be embodied as software, firmware, hardware or any combination thereof. The controller may be part of a system controller or a component controller. The memory 260 may include computer-readable operating instructions that, when executed by the controller 250 provides functions of the NIC 110. Such functions may include the functions of synchronizing communications described below and below. The computer readable instructions may be encoded within the memory 260. Memory 260 may comprise computer readable storage media including any volatile, nonvolatile, magnetic, optical, or electrical media, such as, but not limited to, a random access memory (RAM), read-only memory (ROM), non-volatile RAM (NVRAM), electrically-erasable programmable ROM (EEPROM), flash memory, or any other storage medium.

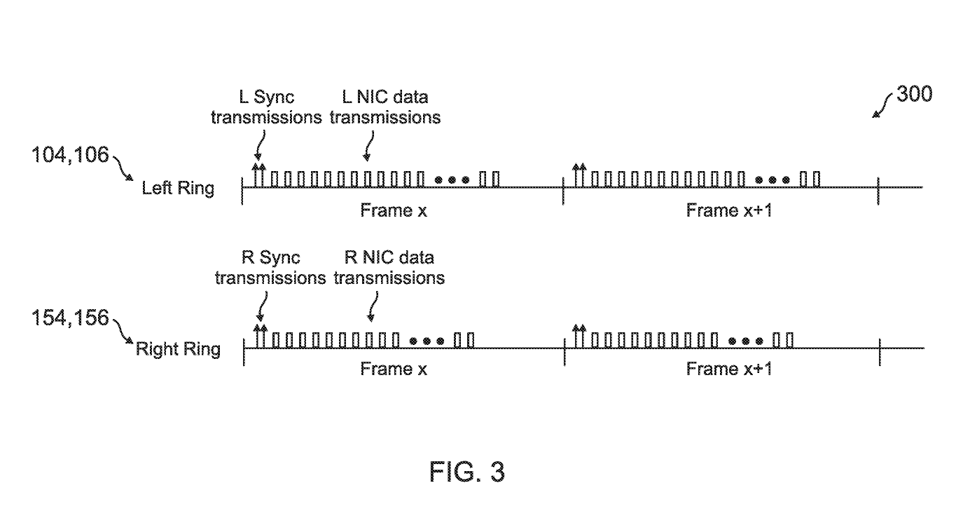

FIG. 3 is an example diagram of data transmissions on each network side 102 and 152. Note that unless there is a failure, the data transmissions will be identical between the two redundant rings 104, 106 and 154, 156 on each side 102 and 152 of the network 100. However the transmissions between the first side 102 and the second side 152 of the network are typically not identical. This is because there is different data and typically a different number of transmissions on each side 102 and 152.

In an embodiment, the data transmissions occur within frames at a periodic rate (e.g. for example 80hz). Individual data transmissions from the NICs 110 are synchronized in time via offsets from two special transmissions at the start of each frame called “sync transmissions”. There are two sync transmissions that are each respectively sourced from the master and back-up master NICs (such as 110-1 and 110-2). A network side can operate with only one sync transmission in case of a failure of a master or back-up master NIC (such as 110-1 and 110-2).

The two network sides 102 and 152 are synchronized to each other as shown in the FIG. 3. At network start-up an algorithm is used to ensure the master & back-up master NICs on both sides 110-1, 110-2 and 160-1 and 160-2 are all synchronized to each other as shown in synchronization flow diagram of FIG. 400. In an embodiment, all NICs contain data tables stored in non-volatile memory that contains the information that governs the frame rate and transmission timings of all the NICs on the network 100 as discussed above.

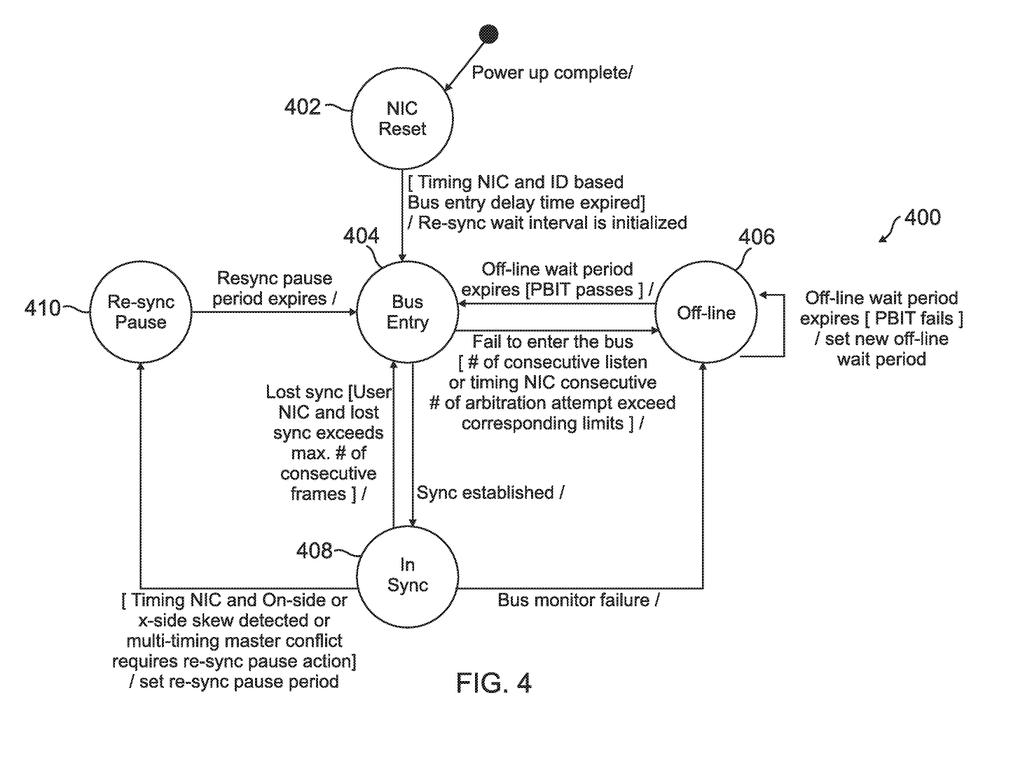

The example synchronization flow diagram 400 of FIG. 4 shows a series of steps that occur in a particular order. The order of steps may occur in a different order in other embodiments. Hence, embodiment are not limited to the specific order as set out in FIG. 4. The synchronization flow diagram 400 starts at step (402) once power up has been complete. Once power up is complete, at step (402) a network interface card (NIC) reset occurs. At step (402), a re-sync wait interval is initialized. Once a timing NIC and ID based entry delay time has expired, bus entry of data form a client unit is attempted at bus entry step (404). If data is successfully entered in the bus at bus entry step (404), synchronization is established and the synchronization is monitored at in sync step (408). However, if the data is not successfully entered into the bus at step (404), an off line wait period is set at offline step (406). In an embodiment, offline step (406) is initiated when the data has failed to enter the bus when a select number of consecutive listen or timing NIC has occurred or a consecutive number of arbitration attempts have exceeded a set limit.

At offline step (406) a set offline wait period is observed. When the offline wait period has expired, the data is again tried to be entered at the bus entry step (404). If the offline wait period expires and a Power-up Built in Test (PBIT) fails, a new offline time wait period is observed at offline step (406). Once the offline period expires and the PBIT passes, the data is entered into the bus at bus entry step (404).

The synchronization is monitored at in sync step (408). If there is a sync bus monitor failure detected at the in sync step 408, the process continues at the offline step (406) with an offline wait period as discussed above. Moreover, if the monitoring at in sync step (408) detects that a user NIC lost sync exceeds a maximum defined number of connective frames, a lost sync condition is determined and the data in entered once again on the bus at bus entry step (404).

Moreover, when a timing NIC and on-side or x-side skew is detected or multi-timing master conflict requires re-sync pause action at the monitoring in sync step (408), a re-sync pause step (410) is used that sets a re-sync pause period. Once the resync pause period, the data is entered on the bus at bus entry step (404).

In an embodiment, an active coupler (such as 202, 210 and 220 of FIG. 2) passes all data it receives from its network input to the NIC 110 and its network outputs, unless the NIC 110 requests to transmit by sending a Request To Send (RTS) to the active coupler and the active coupler sees an opening on the ring (one slot gap time has passed with no incoming data) to switch over to allow the NIC 110 to transmit by asserting its Clear To Send signal (CTS). At that point, the NIC 110 can transmit until it de-asserts RTS or its maximum transmission slot time expires. In this manner each node is rate constrained monitored independently by the simple, no complex circuitry, active coupler, while still being synchronous to network. Note that there is no control of synchronous timeline in the active coupler since, in some embodiments, the NIC timeline algorithms master the time.

### EXAMPLE EMBODIMENTS

Example 1 is a redundant communication network that includes a first set of network interface controllers and a second set of network interface controllers. The first set of network interface controllers forms at least a first ring communication loop. At least one of the network interface controllers in the first set of network interface controllers providing a gateway to at least one first client unit. The first set of network interface controllers include a first master network interface controller and a first backup master interface controller. The second set of network interface controllers form at least a second communication loop. At least one of the network interface controllers in the second set of network interface controllers provide a gateway to at least one second client unit. The second set of network interface controllers include a second master network interface controller and a second backup master interface controller. The first master network interface controller and the first backup master interface controller of the first set of network interface controller are in a cross-side linked commutation configuration with the second master network interface controller and the second backup master interface controller of the second set of network interface controllers.

Example 2, includes the redundant communication network of Example 1, wherein the cross-side linked commutation configuration further includes the first master network interface controller being configured to communicate data to the second master network interface controller. The first backup master network interface controller is also configured to communicate data to the second backup master network interface controller. The second master network interface controller is configured to communicate data to the first redundant master network interface controller, and the second backup master network interface controller is configured to communicate data to the first master network interface controller.

Example 3 includes the redundant communication network of any of the Examples 1-2, wherein the at least one first ring communication loop of the first set of network interface controllers includes first primary ring communication loop and a first redundant communication loop. Moreover, the at least one second ring communication loop of the second set of network interface controllers includes a second primary ring communication loop and a second redundant communication loop.

Example 4 includes the redundant communication network of any of the Examples 1-2, wherein each network interface controller of the first set of network interface controllers has a first active coupler that is in communication with first active couplers of neighbor network interface controllers to form the first primary ring communication loop and a second active coupler that is in communication with second active couplers of neighbor network interface controllers to form the first redundant ring communication loop. Moreover, each network interface controller of the second set of network interface controllers has a first active coupler that is in communication with first active couplers of neighbor network interface controllers to form the second primary ring communication loop and a second active coupler that is in communication with second active couplers of neighbor network interface controllers to form the second redundant ring communication loop.

Example 5 includes the redundant communication network of any of the Examples 1-4, wherein time synchronization within the first set of network interface controllers, within the second set of network interface controllers and between the first set of network interface controllers and the second set of network interface controllers is maintained under multiple fault conditions.

Example 6 includes the redundant communication network of any of the Examples 1-5, wherein each network interface controller of the first and second sets of the network interface controllers further includes a data interface, a first active coupler and a second active coupler. The data interface couples communications between the network interface controller and at least one client unit. The first active coupler is in communication with first active couplers of neighbor network interface controllers and the second active coupler in communication with second active couplers of the neighbor network interface controllers.

Example 7 includes the redundant communication network of any of the Examples 1-6, wherein the first master network interface controller and the first backup master interface controller each include a third active coupler to enable communications between the first set of network interface controllers and the second set of network interface controllers. In addition, the second master network interface controller and the second backup master interface controller also each include a third active coupler to enable communications between the second set of network interface controllers and the first set of network interface controllers

Example 8 includes the redundant communication network of any of the Examples 1-7, wherein each network interface controller of the first and second set of network interface controllers further includes a main power input to couple a main external power source to select circuitry of the network interface controller and a power auxiliary input to couple an external auxiliary power source to at least one of the first active coupler and the second active coupler. The at least one of the first active coupler and the second active coupler are isolated from the main power input to the network interface controller such that a fault associated with the main power input does not cause a loss of the communication functions of the at least one of the first and second active coupler.

Example 9 includes the redundant communication network of any of the Examples 1-8, wherein the first active coupler and the second active coupler each including a transceiver.

Example 10 is a redundant data communication network that includes a first set of network interface controllers and a second set of network interface controllers. Each network interface controller in the first set of network interface controllers provides a gateway to at least one associated first client unit. Each network interface controller in the first set of network interface controllers is in communication with each of the other network interface controllers in the first set of network controllers in at least a first ring counter rotating redundant configuration to maintain data communications under fault conditions. Communication between the first set of network interface controllers are time synchronized. Each network interface controller in the second set of network interface controllers provides a gateway to at least one associated second client unit. Each network interface controller in the second set of network interface controllers is in communication with each of the other network interface controllers in the second set of network controllers in at least one second ring counter rotating redundant configuration to maintain data communications under fault conditions. Communication between the second set of network interface controllers being time synchronized. The first set of network interface controllers include a first master network interface controller and a first backup master network interface controller and the second set of the network interface controllers including a second master network interface controller and a second backup master network interface controller. The first master network interface controller and the first backup master network interface controller in the first set of network interface controllers are in communication with the second master network interface controller and the second backup master network interface controller in the second set of network interface controllers in a cross-side link communication configuration. Communications between the first set of network interface controllers and the second set of network interfaces controllers via the first master network interface controller and a first backup master network interface controller and the second master network interface controller and a second backup master network interface controller further are time synchronized, wherein the time synchronization within the first set of network interface controllers, within the second set of network interface controllers and between the first set of network interface controllers and the second set of network interface controllers are maintained under multiple fault conditions.

Example 11 includes the redundant communication network of Examples 10, wherein each network interface controller of the first and second sets of the network interface controllers further includes a data interface, a primary active coupler and a backup active coupler. The data interface couples communications between the network interface controller and the at least one associated first and second client unit. The primary active coupler is in communication with primary active couplers of neighbor network interface controllers in the respective at least one first and second ring counter rotating redundant configuration. The backup active coupler is in communication with backup active couplers of the neighbor network interface controllers in the respective at least one first and second ring counter rotating redundant configuration.

Example 12 includes the redundant communication network of any of the Examples 10-11, further wherein the primary active coupler is configured to pass communication data between the neighbor network interface controllers in the respective at least one first and second ring counter rotating redundant configuration. The primary active coupler is further configured to communicate select communication data to the at least one associated first and second client unit via the data interface and add client unit communication data from the at least one associated first and second client unit to the communication data via the data interface. The backup active coupler is configured to pass communication data between the neighbor network interface controllers in the respective at least one first and second ring counter rotating redundant configuration. The backup active coupler is further configured to communicate select communication data to the at least one associated first and second client unit via the data interface and add client unit communication data from the at least one associated first and second client unit to the communication data via the data interface.

Example 13 includes the redundant communication network of any of the Examples 10-12, wherein the primary active controller and the backup active controller includes a transceiver.

Example 14 includes the redundant communication network of any of the Examples 10-13, wherein each network interface controller of the first and second sets of the network interface controllers further includes a main power input to couple a main external power source to select circuitry of the network interface controller. Each network interface controller further includes a power auxiliary input to couple an external auxiliary power source to one of the primary active coupler and the backup active coupler. The one primary active coupler and the backup active coupler are isolated from the main power input to the network interface controller such that a fault associated with the main power input does not cause a loss of the communication functions of the at least one of the primary and backup active coupler.

Example 15 includes the redundant communication network of any of the Examples 10-14, wherein the at least one first ring counter rotating redundant configuration of the first set of network interface controllers includes a primary ring formed with the primary active couplers and a redundant ring formed with the backup active couplers of the network interface controllers in the first set of network interface controllers. Moreover, the at least one second ring counter rotating redundant configuration of the second set of network interface controllers incudes a primary ring formed with the primary active couplers and a redundant ring formed with the backup active couplers of the network interface controllers in the first set of network interface controllers.

Example 16 includes a network interface controller that includes a data interface, a controller, a memory, a main power input, a first active coupler, a second active coupler and an auxiliary power input. The data interface is configured to couple communications between the network interface controller and at least one client. The controller is configured to control operations of the network interface controller. The memory is configured to store operation instructions executed by the controller. The main power input is configured to power circuitry of the network interface controller. The first active coupler is configured to provide a first communication connection to the network interface controller. The first active coupler is isolated from the circuitry powered via the main power input. The second active coupler is configured to provide a second communication connection to the network interface controller. The auxiliary power input is configured to couple an auxiliary power to the first active coupler such that the network interface controller may transfer data even if one of the network interface controller and the main power fails.

Example 17 includes the network interface controller of Example 16, wherein the first active controller includes a first transceiver and the second active controller includes a second transceiver.

Example 18 includes the network interface controller of any Examples 16-17, further including a third active coupler configured to provide a third communication port to the network interface controller.

Example 19 includes the network interface controller of any Examples 16-18, wherein the third controller is configured to provide a cross-side link communication port for the network interface controller.

Example 20 includes the network interface controller of any Examples 16-19, wherein the memory is configured to store data tables used by the controller to control frame rate and transmission timings.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A redundant communication network comprising:
a first set of network interface controllers forming at least a first ring communication loop, at least one of the network interface controllers in the first set of network interface controllers providing a gateway to at least one first client unit, the first set of network interface controllers including a first master network interface controller and a first backup master interface controller; and
a second set of network interface controllers forming at least a second communication loop, at least one of the network interface controllers in the second set of network interface controllers providing a gateway to at least one second client unit, the second set of network interface controllers including a second master network interface controller and a second backup master interface controller, the first master network interface controller and the first backup master interface controller of the first set of network interface controllers being in a cross-side linked commutation configuration with the second master network interface controller and the second backup master interface controller of the second set of network interface controllers.

2. The redundant communication network of claim 1, wherein the cross-side linked commutation configuration further comprises:
the first master network interface controller being configured to communicate data to the second master network interface controller;
the first backup master network interface controller being configured to communicate data to the second backup master network interface controller;
the second master network interface controller being configured to communicate data to the first redundant master network interface controller; and
the second backup master network interface controller being configured to communicate data to the first master network interface controller.

3. The redundant communication network of claim 1, wherein:
the at least one first ring communication loop of the first set of network interface controllers includes first primary ring communication loop and a first redundant communication loop;
the at least one second ring communication loop of the second set of network interface controllers includes a second primary ring communication loop and a second redundant communication loop.

4. The redundant communication network of claim 3, wherein:
each network interface controller of the first set of network interface controllers having a first active coupler that is in communication with first active couplers of neighbor network interface controllers to form the first primary ring communication loop and a second active coupler that is in communication with second active couplers of neighbor network interface controllers to form the first redundant ring communication loop; and
each network interface controller of the second set of network interface controllers having a first active coupler that is in communication with first active couplers of neighbor network interface controllers to form the second primary ring communication loop and a second active coupler that is in communication with second active couplers of neighbor network interface controllers to form the second redundant ring communication loop.

5. The redundant communication network of claim 1, wherein time synchronization within the first set of network interface controllers, within the second set of network interface controllers and between the first set of network interface controllers and the second set of network interface controllers is maintained under multiple fault conditions.

6. The redundant communication network of claim 1, wherein each network interface controller of the first and second sets of the network interface controllers further comprises:
a data interface coupling communications between the network interface controller and at least one client unit;
a first active coupler in communication with first active couplers of neighbor network interface controllers; and
a second active coupler in communication with second active couplers of the neighbor network interface controllers.

7. The redundant communication network of claim 6, wherein:
the first master network interface controller and the first backup master interface controller each include a third active coupler to enable communications between the first set of network interface controllers and the second set of network interface controllers; and
the second master network interface controller and the second backup master interface controller also each include a third active coupler to enable communications between the second set of network interface controllers and the first set of network interface controllers.

8. The redundant communication network of claim 6, wherein each network interface controller of the first and second set of network interface controllers further comprises:
a main power input to couple a main external power source to select circuitry of the network interface controller; and
a power auxiliary input to couple an external auxiliary power source to at least one of the first active coupler and the second active coupler, the at least one of the first active coupler and the second active coupler being isolated from the main power input to the network interface controller such that a fault associated with the main power input does not cause a loss of the communication functions of the at least one of the first and second active coupler.

9. The redundant communication network of claim 6, wherein the first active coupler and the second active coupler each including a transceiver.

10. A redundant data communication network comprising:
a first set of network interface controllers, each network interface controller in the first set of network interface controllers providing a gateway to at least one associated first client unit, each network interface controller in the first set of network interface controllers being in communication with each of the other network interface controllers in the first set of network controllers in at least a first ring counter rotating redundant configuration to maintain data communications under fault conditions, communication between the first set of network interface controllers being time synchronized;
a second set of network interface controllers, each network interface controller in the second set of network interface controllers providing a gateway to at least one associated second client unit, each network interface controller in the second set of network interface controllers being in communication with each of the other network interface controllers in the second set of network controllers in at least one second ring counter rotating redundant configuration to maintain data communications under fault conditions, communication between the second set of network interface controllers being time synchronized; and
the first set of network interface controllers including a first master network interface controller and a first backup master network interface controller and the second set of the network interface controllers including a second master network interface controller and a second backup master network interface controller, the first master network interface controller and the first backup master network interface controller in the first set of network interface controllers being in communication with the second master network interface controller and the second backup master network interface controller in the second set of network interface controllers in a cross-side link communication configuration, communications between the first set of network interface controllers and the second set of network interfaces controllers via the first master network interface controller and a first backup master network interface controller and the second master network interface controller and a second backup master network interface controller further being time synchronized, wherein the time synchronization within the first set of network interface controllers, within the second set of network interface controllers and between the first set of network interface controllers and the second set of network interface controllers are maintained under multiple fault conditions.

11. The redundant data communication network of claim 10, wherein each network interface controller of the first and second sets of the network interface controllers further comprises:
a data interface coupling communications between the network interface controller and the at least one associated first and second client unit;
a primary active coupler in communication with primary active couplers of neighbor network interface controllers in the respective at least one first and second ring counter rotating redundant configuration; and
a backup active coupler in communication with backup active couplers of the neighbor network interface controllers in the respective at least one first and second ring counter rotating redundant configuration.

12. The redundant data communication network of claim 11, further wherein:
the primary active coupler is configured to pass communication data between the neighbor network interface controllers in the respective at least one first and second ring counter rotating redundant configuration, the primary active coupler is further configured to communicate select communication data to the at least one associated first and second client unit via the data interface and add client unit communication data from the at least one associated first and second client unit to the communication data via the data interface; and
the backup active coupler is configured to pass communication data between the neighbor network interface controllers in the respective at least one first and second ring counter rotating redundant configuration, the backup active coupler is further configured to communicate select communication data to the at least one associated first and second client unit via the data interface and add client unit communication data from the at least one associated first and second client unit to the communication data via the data interface.

13. The redundant data communication network of claim 11, wherein the primary active controller and the backup active controller includes a transceiver.

14. The redundant data communication network of claim 11, wherein each network interface controller of the first and second sets of the network interface controllers further comprise:
a main power input to couple a main external power source to select circuitry of the network interface controller; and
a power auxiliary input to couple an external auxiliary power source to one of the primary active coupler and the backup active coupler, the one primary active coupler and the backup active coupler being isolated from the main power input to the network interface controller such that a fault associated with the main power input does not cause a loss of the communication functions of the at least one of the primary and backup active coupler.

15. The redundant data communication network of claim 12, wherein:
the at least one first ring counter rotating redundant configuration of the first set of network interface controllers includes a primary ring formed with the primary active couplers and a redundant ring formed with the backup active couplers of the network interface controllers in the first set of network interface controllers; and
the at least one second ring counter rotating redundant configuration of the second set of network interface controllers incudes a primary ring formed with the primary active couplers and a redundant ring formed with the backup active couplers of the network interface controllers in the first set of network interface controllers.

16. A network interface controller comprising:
a data interface configured to couple communications between the network interface controller and at least one client;
a controller configured to control operations of the network interface controller;
a memory configured to store operation instructions executed by the controller;
main power input configured to power circuitry of the network interface controller;
a first active coupler configured to provide a first communication connection to the network interface controller, the first active coupler being isolated from the circuitry powered via the main power input;
a second active coupler configured to provide a second communication connection to the network interface controller; and
an auxiliary power input configured to couple an auxiliary power to the first active coupler such that the network interface controller may transfer data even if one of the network interface controller and the main power fails.

17. The network interface controller of claim 16, wherein:
the first active controller includes a first transceiver; and
the second active controller includes a second transceiver.

18. The network interface controller of claim 17, further comprising:
a third active coupler configured to provide a third communication port to the network interface controller.

19. The network interface controller of claim 18, wherein the third controller is configured to provide a cross-side link communication port for the network interface controller.

20. The network interface controller of claim 16, wherein the memory is configured to store data tables used by the controller to control frame rate and transmission timings.
